(19) United States
(12) Patent Application Publication
(10) Pub. No.: US 2015/0019671 A1
(43) Pub. Date: Jan. 15, 2015

(54) INFORMATION PROCESSING SYSTEM, TROUBLE DETECTING METHOD, AND INFORMATION PROCESSING APPARATUS

(71) Applicant: FUJITSU LIMITED, Kawasaki-shi (JP)

(72) Inventors: Lin YASUDA, Kawasaki (JP); Kazushige KUROKAWA, Paderborn (DE); Yasuyuki FUKUBA, Kawasaki (JP); Eiko NAKAGAWA, Kawasaki (JP)

(73) Assignee: FUJITSU LIMITED, Kawasaki-shi (JP)

(21) Appl. No.: 14/499,607

(22) Filed: Sep. 29, 2014

Related U.S. Application Data
(63) Continuation of application No. PCT/JP2012/058754, filed on Mar. 30, 2012.

(51) Int. Cl. H04L 12/26; H04L 12/935; H04L 12/24

(52) U.S. Cl. CPC H04L 43/0805; H04L 43/10; H04L 41/04; H04L 49/30
USPC 709/208; 713/320

(57) ABSTRACT

A first information processing apparatus includes a first input/output unit that is capable of communicating with a second information processing apparatus for monitoring the first information processing apparatus and transmits a notification signal transmitted from a first input/output device to the second information processing apparatus even when no notification from an operating system that is operated by a processor is obtained. The second information processing apparatus includes a second input/output unit and a trouble detector that detects generation of a trouble on a network when the second input/output device does not receive the notification signal from the first input/output device.

### CROSS-REFERENCE TO RELATED APPLICATION

This application is a continuation of International Application No. PCT/JP2012/058754, filed on Mar. 30, 2012 and designating the U.S., the entire contents of which is incorporated herein by reference.

### FIELD

The embodiments discussed herein are related to an information processing system, a trouble detecting method, and an information processing apparatus.

### BACKGROUND

Conventionally, Hadoop has been known as open source software that performs distributed processing on large-scale data effectively. A large number of elements constitute the Hadoop. For example, a Hadoop distributed file system (HDFS) as a distributed file system and Hadoop MapReduce that executes distributed processing on the large-scale data have been known mainly.

A system using the Hadoop includes a “master server” managing the entire system and a plurality of “slave servers” executing parallel processing. The master server uses heartbeats in order to monitor running statuses of the slave servers. For example, each of the slave servers transmits the heartbeat to the master server every three seconds. When the master server does not receive the heartbeat from the slave server for 10 minutes, it determines that the slave server has undergone breakdown and isolates the slave server from the system. In this manner, the slave server is made into a recovery mode.

When a new slave server is added to the system, the master server transmits a direction to the new slave server and causes it to execute an incorporation operation into the system. When the master server receives the heartbeat from the new slave server periodically, it knows that the new slave server has been incorporated into the system normally. The system using the Hadoop performs monitoring and management of troubles of the slave servers with the heartbeats in this manner.

As a general technique of monitoring a trouble of the system, for example, known has been a technique of monitoring a running status of a slave server as a monitoring target device and responding the running status and change of the status of the monitoring target device to a client terminal in accordance with a request from the client terminal. A server device used as the slave server that detects a trouble of software thereof by the device itself and shuts off connection with other devices has been also known.

The conventional technique, however, has the following problem. That is, when running notification information such as the heartbeat indicating that the slave server operates normally is not received from the slave server, whether the slave server has a trouble or a network has a trouble is not always distinguished.

For example, two causes are considered when the master server does not receive the heartbeat from the slave server. A first one is that the slave server itself undergoes breakdown and does not transmit the heartbeat. A second one is that the slave server transmits the heartbeat but the heartbeat does not reach to the master server because a trouble occurs on the network connecting the slave server and the master server.

The cause due to which the master server does not receive the heartbeat is not specified because the master server makes trouble monitoring based on whether it receives the heartbeat from the slave server. In addition, when the master server does not receive the heartbeat, the trouble is not analyzed by the master server. Furthermore, when the master server does not receive the heartbeat, it determines that the slave server has a trouble without exception and isolates the slave server from the system. Based on this, a recovery operation is executed on the slave server even when the network has a trouble, resulting in a wasteful operation.

Examples of the conventional techniques are disclosed in Japanese Laid-open Patent Publication No. 2009-182667 and Japanese Laid-open Patent Publication No. 2000-307600.

### SUMMARY

According to an aspect of the embodiment, an information processing system includes a first information processing apparatus; and a second information processing apparatus that monitors the first information processing apparatus. The first information processing apparatus includes a first input/output device; a processor which executes an operating system operates; and a first input/output unit that is capable of communicating with the second information processing apparatus and transmits a notification signal transmitted from the first input/output device to the second information processing apparatus even when no notification from the operating system is obtained. The second information processing apparatus includes a second input/output device; and a trouble detector that detects occurrence of a trouble on the network when the second input/output device does not receive the notification signal from the first input/output device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the entire configuration of a system according to a first embodiment;

FIG. 2 is a diagram for explaining flow of an NIC beat;

FIG. 3 is a diagram illustrating an example of the hardware configuration;

FIG. 4 is a functional block diagram illustrating the configuration of a slave server;

FIG. 5 is a view illustrating an example of the data structure of a heartbeat;

FIG. 6 is a view illustrating an example of pieces of information that are managed by a status management unit;

FIG. 7 is a view illustrating an example of the data structure of the NIC beat;

FIG. 8 is a functional block diagram illustrating the configuration of a master server;

FIG. 9 is a view illustrating an example of pieces of information that are managed by a slave server management unit;

FIG. 10 is a flowchart illustrating a sequence in a normal state;

FIG. 11 is a flowchart illustrating a sequence in an abnormal state of an OS;

FIG. 12 is a flowchart illustrating a sequence in a power saving mode shift state.

FIG. 13 is a flowchart illustrating a sequence in an abnormal state of a network;

FIG. 14 is a flowchart illustrating flow of NIC beat transmission processing that is executed by the slave server;

FIG. 15 is a flowchart illustrating flow of NIC beat receiving processing that is executed by the master server; and

FIG. 16 is a flowchart illustrating flow of status monitoring processing that is executed by the master server.

### DESCRIPTION OF EMBODIMENTS

Preferred embodiments will be explained with reference to accompanying drawings. It is to be noted that the embodiments do not limit the invention.

### [a] First Embodiment

### Overall Configuration

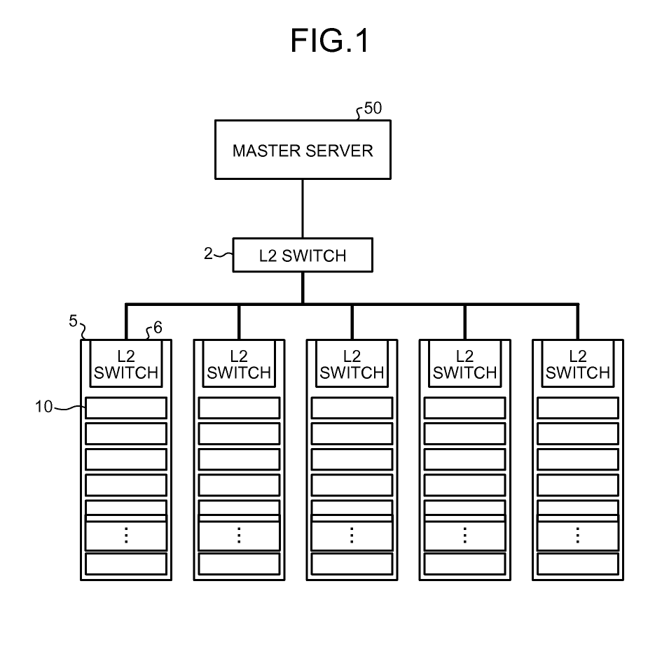

FIG. 1 is a diagram illustrating an example of the entire configuration of a system in a first embodiment. As illustrated in FIG. 1, the system includes a master server 50, a plurality of racks 5, and a layer 2 (L2) switch and they are connected to one another through a network in a communicable manner. The system is a distributed processing system using Hadoop.

The master server 50 is a server device that manages the plurality of racks 5 and respective slave servers 10 mounted on the racks 5. For example, the master server 50 is a name server of a Hadoop distributed file system (HDFS) or a job tracker of MapReduce.

The L2 switch 2 is a relay device that connects L2 switches 6 and the slave servers 10 that are accommodated in the respective racks 5 and the master server 50. The L2 switch 2 may be an L3 switch or a router.

The racks 5 are devices accommodating electronic devices that are installed on a data center or the like. Each of the racks 5 accommodates equal to or more than one slave server(s) 10 and the L2 switch 6. Each L2 switch 6 is a relay device that relays communication between each slave server 10 and the L2 switch 2. The L2 switch 6 may be an L3 switch or a router. Each slave server 10 is a server that executes distributed processing. For example, the slave server 10 is a data node of the HDFS, a task tracker of MapReduce, or the like.

In such a state, each slave server 10 includes a network card. The network card transmits a notification signal for notifying of a fact indicating that a network operates normally regardless of a running status of a higher-order OS as long as the network card operates normally. The notification signal is referred to as a network interface card (NIC) beat herein. The network card of each slave server 10 transmits the generated NIC beat to the master server 50. When the master server 50 does not receive the NIC beat from the network card of each slave server 10, it detects that the network has a trouble. A possibility that the network card has a trouble is generally higher than a possibility that the higher-order OS has a trouble. The master server 50 may detect a status of the higher-order OS whether the higher-order OS operates normally and so on from a heartbeat or the like from the higher-order OS and put detected information about the status of the higher-order OS into the NIC beat. With this, a state where the network has no trouble but the higher-order OS has a trouble can be notified.

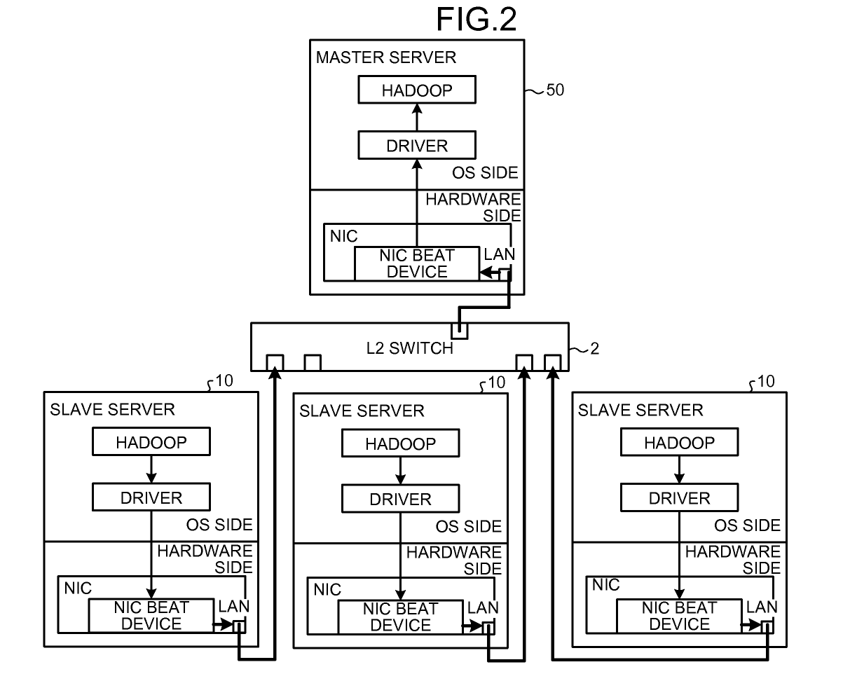

The flow of the NIC beat will now be described. FIG. 2 is a diagram for explaining the flow of the NIC beat. As illustrated in FIG. 2, Hadoop that is executed in each slave server 10 regularly issues a heartbeat as the running notification information indicating that the OS operates normally. The heartbeat is transmitted to the NIC through a driver. Then, an NIC beat device in the NIC generates an NIC beat in addition to the received heartbeat and transmits it to the master server 50 through a local area network (LAN) port. The L2 switch 2 receives the NIC beat and relays it to the master server 50.

An NIC beat device that is executed in an NIC of the master server 50 receives the NIC beat transmitted from each slave server 10 through the L2 switch 2. Then, the NIC beat device executes analysis of the NIC beat. Thereafter, the NIC beat device extracts the heartbeat from the NIC beat and transmits it to the Hadoop through the driver.

In this manner, the NIC beat device of each slave server 10 notifies the master server 50 of the NIC beat generated in addition to the heartbeat of the OS, and the master server 50 receives the NIC beat from the NIC beat device of each slave server 10. The NIC beat device of each slave server 10 transmits generation contents of the heartbeat that are contained in the NIC beat when the heartbeat is generated. On the other hand, the NIC beat device of each slave server 10 transmits a fact indicating that no heartbeat is generated, the fact transmitted being contained in the NIC beat, when no heartbeat is generated. As a result, when the master server 50 can have received the NIC beat, it can determine that no trouble is generated on at least the network. Accordingly, the master server 50 can classify troubles.

Hardware Configurations

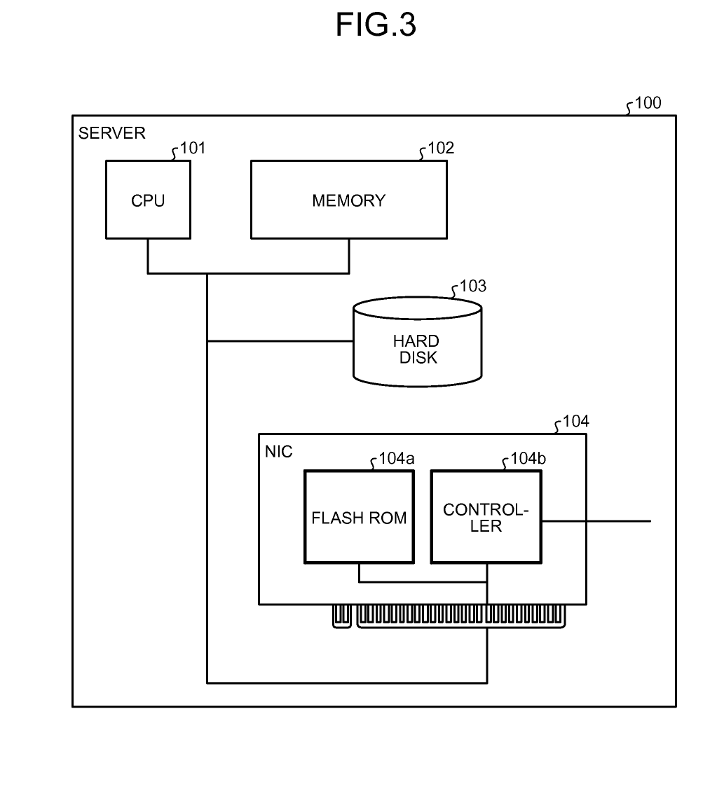

Next, the hardware configurations of the slave servers 10 and the master server 50 are described. The respective servers have the same configuration and description is made while each server is assumed to be a server 100 herein. FIG. 3 is a diagram illustrating an example of the hardware configuration.

As illustrated in FIG. 3, the server 100 includes a central processing unit (CPU) 101, a memory 102, a hard disk 103, and an NIC 104. The hardware herein is merely an example and the hardware is not limited thereto.

The CPU 101 is a processor that controls processing of the entire server 100. For example, the CPU 101 executes the Hadoop and the driver. The Hadoop generates the heartbeat and transmits it to the NIC. The memory 102 is a storage device for storing therein computer programs that are executed by the CPU 101 and pieces of data that are used by the respective programs. The hard disk 103 is a storage device for storing therein pieces of data as targets of the distributed processing, tables, databases, and the like.

The NIC 104 includes a flash read only memory (ROM) 104a and a controller 104b, and executes generation, transmission, reception, and the like of the NIC beat. An electric current is supplied to the NIC 104 separately from that to the CPU 101. That is to say, even when supply of a power to the CPU 101 is shut off, power is supplied to the NIC 104.

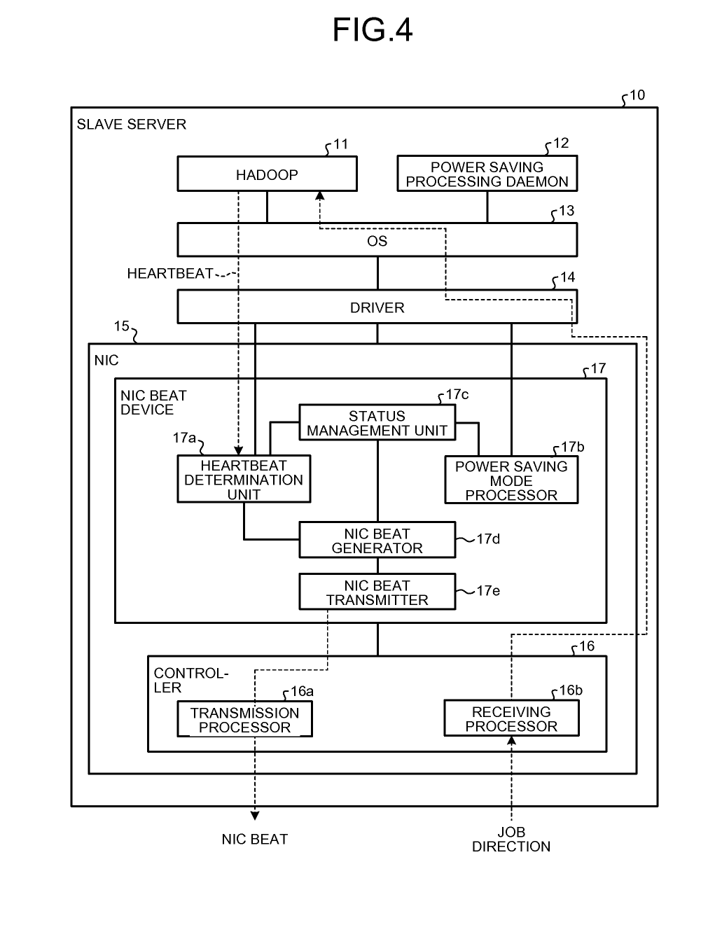

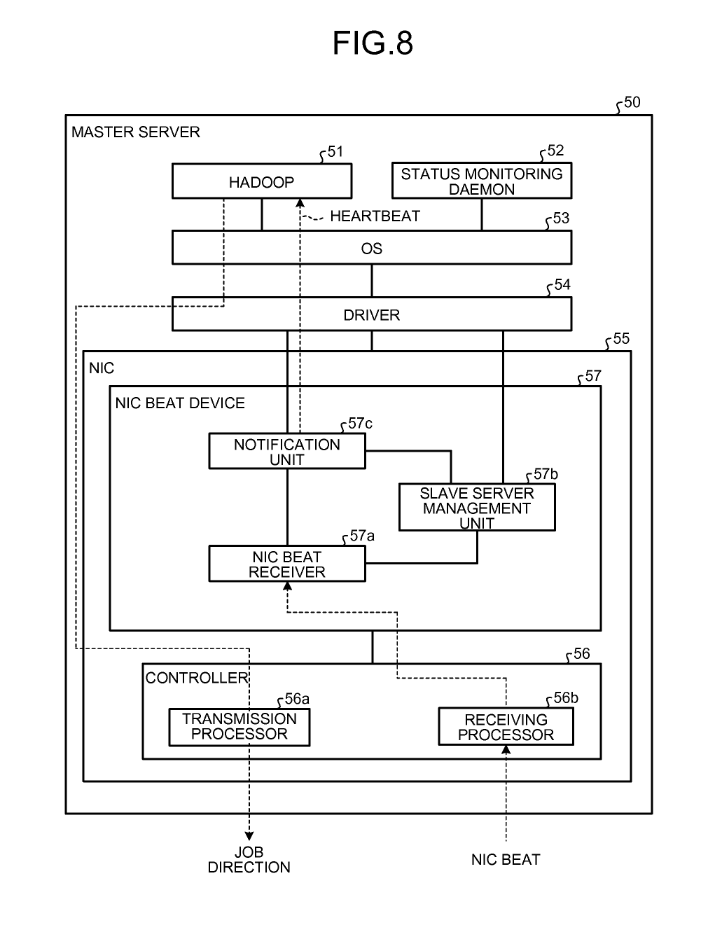

The flash ROM 104a holds an electronic circuit and the like that execute the same functions as those of processors as illustrated in FIG. 4 and FIG. 8, which will be described later. That is to say, the flash ROM 104a executes the same functions as those of the NIC beat device of each slave server 10 or the NIC beat device of the master server 50. The controller 104b executes transmission of data to another device from the NIC 104 and reception of data transmitted from another device. For example, the controller 104b executes the transmission and reception of the NIC beat.

Although the flash ROM 104a holds the electronic circuit and the like that executes the same functions as those of the processors as illustrated in FIG. 4 and FIG. 8, the invention is not limited thereto. For example, the flash ROM 104a may store therein computer programs for executing the same functions as those of the processors as illustrated in FIG. 4 and FIG. 8 and the controller 104b may read and execute the programs so as to execute the same functions as those of the processors as illustrated in FIG. 4 and FIG. 8.

Configuration of Slave Server

FIG. 4 is a functional block diagram illustrating the configuration of the slave server. As illustrated in FIG. 4, the slave server 10 includes a Hadoop 11, a power saving processing daemon 12, an OS 13, a driver 14, and an NIC 15.

The Hadoop 11 is open source software that performs distributed processing on large-scale data effectively and is executed by the OS 13. The Hadoop 11 executes normal monitoring in the slave server 10. For example, the Hadoop 11 generates a heartbeat every three seconds and transmits it to the NIC 15.

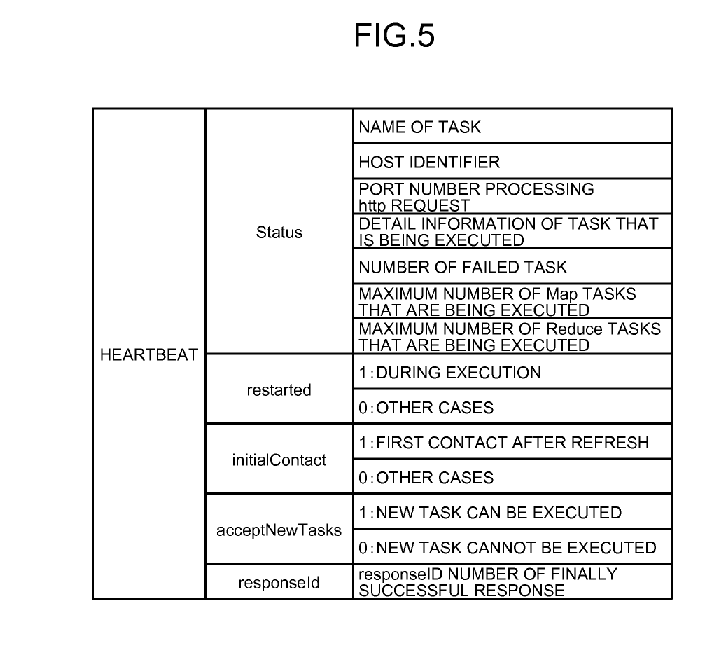

The heartbeat is described herein. FIG. 5 is a view illustrating an example of the data structure of the heartbeat. As illustrated in FIG. 5, for example, the heartbeat is constituted by “status” data, “restarted” data, “initialContact” data, “acceptNewTasks” data, and “responseId” data.

The “status” data is formed by a name of a task, a Host identifier, a port number processing a hyper transfer protocol (http) request, detail information of a task that is being executed, the number of failed task, the maximum number of Map tasks that are being executed, and the maximum number of Reduce tasks that are being executed. “1” is set to the “restarted” data during execution of a process and “0” is set to the “restarted” data in other cases. “1” is set to the “initialContact” data in the case of first communication after refresh and “0” is set to the “initialContact” data in other cases. “1” is set to the “acceptNewTasks” data when a new task can be executed and “0” is set to the “initialContact” data when the new task is not executed. The “responseId” data is an identification (ID) number of a finally successful response.

Returning back to FIG. 4, the power saving processing daemon 12 is a processor that causes the slave server 10 to shift to be in a power saving mode or causes the slave server 10 to recover from the power saving mode. The power saving processing daemon 12 is executed by the OS 13.

For example, when the power saving processing daemon 12 detects that there is no job and no task as an execution target by the slave server 10, the power saving processing daemon 12 powers off the components other than the NIC 15. The power-off herein indicates not that all the power supplies are completely shut off but that the power supply is adjusted to a minimum power amount with which the job or the task can be generated. When the power saving processing daemon 12 detects that the job or the task is generated on the slave server 10 or when the power saving processing daemon 12 receives a recovery direction from the master server 50, it causes a power supply status of the slave server 10 to shift to be in a normal mode from the power saving mode.

The OS 13 is a processor that manages the hard disk and the memory and executes applications. The OS 13 executes the Hadoop 11, the power saving processing daemon 12, and the driver 14. Furthermore, the OS 13 manages generation of the job or the task with a minimum power amount in the power saving mode.

The driver 14 is a processor that controls devices attached in the slave server 10 and devices connected externally. To be specific, the driver 14 controls communication between the OS 13 or the applications and the NIC 15. For example, the driver 14 receives the heartbeat transmitted from the Hadoop 11 from the OS 13 and transmits it to the NIC 15. The driver 14 receives an error notification transmitted from the NIC 15 and transmits it to the Hadoop 11 through the OS 13. The OS 13 executes the driver 14. The driver 14 may be incorporated in the OS 13.

The NIC 15 includes a controller 16 and an NIC beat device 17 and controls generation and transmission of the NIC beat. The NIC 15 also transmits and receives pieces of data, messages, and the like that are generated in the distributed processing system in addition to the NIC beat.

The controller 16 is a processor that includes a transmission processor 16a and a receiving processor 16b, and transmits and receives various pieces of data to and from other slave servers and the master server 50 through the network.

The transmission processor 16a is a processor that transmits various pieces of data. For example, the transmission processor 16a transmits an NIC beat transmitted from the NIC beat device 17 to the master server 50. The transmission processor 16a transmits various pieces of data and messages transmitted from the Hadoop 11 to a server as a destination.

The receiving processor 16b is a processor that receives various pieces of data. For example, the receiving processor 16b receives various pieces of data and messages from other slave servers and transmits them to the Hadoop 11. The receiving processor 16b receives the recovery direction from the power saving mode from the master server 50 and transmits it to the power saving processing daemon 12.

The NIC beat device 17 is a processor that includes a heartbeat determination unit 17a, a power saving mode processor 17b, a status management unit 17c, an NIC beat generator 17d, and an NIC beat transmitter 17e, and executes generation and transmission of the NIC beat by these units. A supply source of the power to the NIC beat device 17 is separated from those to other processors, and even when supply of the power to other processors is shut off, the power is supplied to the NIC beat device 17.

The heartbeat determination unit 17a is a processor that notifies the status management unit 17c of a determination result obtained by determining presence and absence of reception of the heartbeat and contents of the heartbeat. To be specific, the heartbeat determination unit 17a specifies an execution condition of a job, a status of the OS 13, a transmission interval of the heartbeat, and the like from the heartbeat and notifies the status management unit 17c of them. For example, when the “number of failed tasks” in the received heartbeat is equal to or more than “1” or when the “acceptNewTasks” is “0”, the heartbeat determination unit 17a notifies the status management unit 17c of trouble notification information indicating that the OS 13 is abnormal.

When a reception timing of the heartbeat becomes irregular, the heartbeat determination unit 17a notifies the status management unit 17c of the trouble notification information indicating that the OS 13 is abnormal. To be more specific, when the heartbeat is not received every three seconds or when the heartbeat itself is not received, the heartbeat determination unit 17a notifies the status management unit 17c of the trouble notification information indicating that the OS 13 is abnormal. In this case, the heartbeat determination unit 17a does not determine that the slave server 10 is abnormal but determines that it is normal when the slave server 10 is in the power saving mode. The heartbeat determination unit 17a transmits the received heartbeat itself to the NIC beat generator 17d.

The power saving mode processor 17b is a processor that notifies the status management unit 17c of shift condition information to the power saving mode. For example, when the power saving processing daemon 12 causes the slave server 10 to shift to be in the power saving mode, the power saving mode processor 17b notifies the status management unit 17c of shift notification information. When the power saving processing daemon 12 causes the slave server 10 to shift to be in the normal mode from the power saving mode, the power saving mode processor 17b notifies the status management unit 17c of cancellation notification information. Furthermore, when the power saving mode processor 17b receives shift direction information to the power saving mode or shift direction information to the normal mode from the master server 50, the power saving mode processor 17b transmits the direction information to the power saving processing daemon 12.

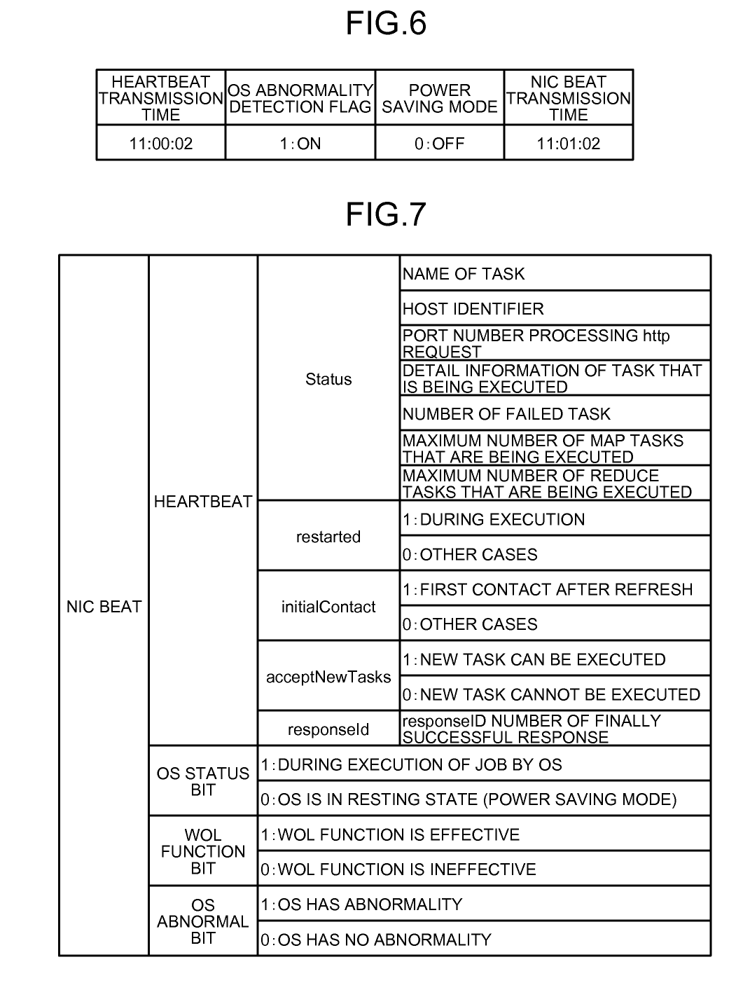

The status management unit 17c is a processor that manages a status of the slave server 10. To be specific, the status management unit 17c is a processor that manages the determination result information notified from the heartbeat determination unit 17a and the shift condition information notified from the power saving mode processor 17b. FIG. 6 is a view illustrating an example of pieces of information that are managed by the status management unit. As illustrated in FIG. 6, the status management unit 17c manages “heartbeat transmission time”, “OS abnormality detection flag”, “power saving mode”, and “NIC beat transmission time”.

The “heartbeat transmission time” managed thereby indicates the time at which the Hadoop 11 has transmitted the heartbeat. The “OS abnormality detection flag” indicates whether the OS 13 has abnormality. 1 is set to the “OS abnormality detection flag” when the OS 13 has abnormality whereas 0 is set to the “OS abnormality detection flag” when the OS 13 does not have abnormality. The “power saving mode” indicates whether the slave server 10 is in the power saving mode. 1 is set to the “power saving mode” when the slave server 10 is in the power saving mode whereas 0 is set to the “power saving mode” when the slave server 10 is in the normal mode. The “NIC beat transmission time” indicates the time at which the NIC beat transmitter 17e has transmitted the NIC beat.

For example, when the status management unit 17c receives the reception time of the heartbeat from the heartbeat determination unit 17a, it stores the time in the “heartbeat transmission time”. Furthermore, when the heartbeat determination unit 17a notifies the status management unit 17c of abnormality of the OS, the status management unit 17c sets the OS abnormality detection flag to 1. In the same manner, when the power saving mode processor 17b notifies the status management unit 17c of the shift notification information, the status management unit 17c sets the “power saving mode” to 1. When the power saving mode processor 17b notifies the status management unit 17c of the cancellation notification information, the status management unit 17c sets the “power saving mode” to 0. The status management unit 17c stores the time at which the NIC beat transmitter 17e has transmitted the NIC beat in the “NIC beat transmission time”.

The NIC beat generator 17d is a processor that generates the NIC beat. To be specific, the NIC beat generator 17d generates the NIC beat based on the OS condition that is managed by the status management unit 17c and the heartbeat input from the heartbeat determination unit 17a at an interval of once per minute and transmits it to the NIC beat transmitter 17e. FIG. 7 is a view illustrating an example of the data structure of the NIC beat. As illustrated in FIG. 7, the NIC beat is formed by the “heartbeat”, an “OS status bit”, a “Wake-on-LAN (WOL) function bit”, and an “OS abnormal bit”.

The “heartbeat” indicates contents of the heartbeat as described above with reference to FIG. 5. The “OS status bit” indicates whether the job is being executed. When the OS executes the job, that is, in the normal mode, “1” is set to the “OS status bit”. When the OS does not execute the job, that is, in the power saving mode, “0” is set to the “OS status bit”. The “WOL function bit” indicates whether a WOL function is effective. When the OS operates in the power saving mode, “1” is set to the “WOL function bit” whereas when the OS operates in the normal mode, “0” is set to the “WOL function bit”. The “OS abnormal bit” indicates whether the OS has abnormality. When the OS has abnormality, “1” is set to the “OS abnormal bit” whereas when the OS is normal, “0” is set to the “OS abnormal bit”.

For example, the NIC beat generator 17d refers to the status management unit 17c at a timing once per minute. The NIC beat generator 17d determines that the OS has abnormality and sets the “OS abnormal bit” to “1” when the “OS abnormality detection flag” that is managed by the status management unit 17c is “1”. When the “power saving mode” that is managed by the status management unit 17c is “1”, the NIC beat generator 17d sets the “OS status bit” to “0” and sets the “WOL function bit” to “1”. Thereafter, the NIC beat generator 17d generates an NIC beat obtained by adding the respective pieces of bit information to the latest heartbeat transmitted from the heartbeat determination unit 17a and transmits it to the NIC beat transmitter 17e.

The NIC beat transmitter 17e is a processer that transmits the NIC beat to the master server 50. To be specific, the NIC beat transmitter 17e transmits the NIC beat transmitted from the NIC beat generator 17d to the transmission processor 16a. Then, the NIC beat transmitter 17e notifies the status management unit 17c of the time at which the NIC beat transmitter 17e has transmitted the NIC beat.

Configuration of Master Server

FIG. 8 is a functional block diagram illustrating the configuration of the master server. As illustrated in FIG. 8, the master server 50 includes a Hadoop 51, a status monitoring daemon 52, an OS 53, a driver 54, and an NIC 55.

The Hadoop 51 is open source software that performs distributed processing on large-scale data effectively and is executed by the OS 53. The Hadoop 51 monitors a running status of each slave server 10 based on the contents of the heartbeat and notification from the status monitoring daemon 52. When it is determined that the slave server 10 has abnormality, the Hadoop 51 isolates the slave server 10 from the network. Furthermore, when it is determined that the network has abnormality, the Hadoop 51 notifies a manager or the like of the abnormality. For example, when the “number of failed tasks” in the “status” of the received heartbeat is described, the Hadoop 51 requests the corresponding slave server 10 to execute the task again or notifies the manager of abnormality of the task.

The status monitoring daemon 52 is a processor that monitors a status of each slave server 10 based on the NIC beat and is executed by the OS 53. To be specific, the status monitoring daemon 52 refers to information that is managed by a slave server management unit 57b and notifies the Hadoop 51 of trouble content information when it detects abnormality of the slave server 10 or abnormality of the network. As a notification method, the status monitoring daemon 52 may transmit a message or output a log.

For example, when the status monitoring daemon 52 detects the slave server 10 of which OS abnormality notification flag that is managed by the slave server management unit 57b is 1 (ON), it notifies the Hadoop 51 of the abnormality of the OS 53 of the corresponding slave server 10. When the status monitoring daemon 52 detects the slave server 10 of which power saving mode that is managed by the slave server management unit 57b is 1 (ON), it notifies the Hadoop 51 of an operation of the corresponding slave server 10 in the power saving mode. When the status monitoring daemon 52 detects the slave server 10 incapable of receiving the NIC beat every one minute based on the NIC beat reception time that is managed by the slave server management unit 57b, it notifies the Hadoop 51 of abnormality of the network.

The OS 53 is a processor that manages a hard disk and a memory and executes applications. The OS 53 executes the Hadoop 51, the status monitoring daemon 52, and the driver 54.

The driver 54 is a processor that controls devices attached in the master server 50 and devices connected externally. To be specific, the driver 54 controls communication between the OS 53 or the applications and the NIC 55. For example, the driver 54 transmits a heartbeat transmitted from an NIC beat device 57 to the Hadoop 51. The driver 54 may be incorporated in the OS 53.

The NIC 55 includes a controller 56 and the NIC beat device 57, and controls reception of the NIC beat, extraction of the heartbeat, and the like. The NIC 55 transmits and receives pieces of data, messages, and the like that are generated in the distributed processing system in addition to the NIC beat.

The controller 56 is a processor that includes a transmission processor 56a and a receiving processor 56b and transmits and receives various pieces of data to and from the respective slave servers 10 through the network. The transmission processor 56a is a processor that transmits various pieces of data. For example, the transmission processor 56a transmits the recovery direction from the power saving mode and pieces of data, messages, and the like that are generated in the distributed processing system to the respective slave servers 10. The receiving processor 56b is a processor that receives respective pieces of data. For example, the receiving processor 56b receives the NIC beats from the respective slave servers 10 and transmits them to an NIC beat receiver 57a.

The NIC beat device 57 is a processor that includes the NIC beat receiver 57a, the slave server management unit 57b, and a notification unit 57c, and manages statuses of the respective slave servers 10 by these units. A supply source of the power to the NIC beat device 57 is separated from those to other processors, and even when supply of the power to other processors is shut off, the power is supplied to the NIC beat device 57.

The NIC beat receiver 57a is a processor that receives the NIC beats transmitted from the respective slave servers 10 and extracts pieces of information. To be specific, the NIC beat receiver 57a extracts the heartbeats from the NIC beats received by the receiving processor 56b and transmits them to the notification unit 57c. The NIC beat receiver 57a updates the pieces of information that are managed by the slave server management unit 57b based on the OS abnormality detection flags, the power saving modes, the slave server names, and the like contained in the received NIC beats.

For example, the NIC beat receiver 57a extracts the slave server name from the NIC beat or the heartbeat so as to specify a corresponding record in the slave server management unit 57b. When there is no corresponding record, the NIC beat receiver 57a generates a new record in the slave server management unit 57b.

The NIC beat receiver 57a notifies the slave server management unit 57b of the time at which it has received the NIC beat. Furthermore, when the “OS abnormality detection flag” in the NIC beat is “1”, the NIC beat receiver 57a notifies the slave server management unit 57b of abnormality of the OS 53 of the slave server 10. On the other hand, when the “OS abnormality detection flag” in the NIC beat is “0”, the NIC beat receiver 57a notifies the slave server management unit 57b of normality of the OS 53 of the slave server 10. In the same manner, when the “power saving mode” in the NIC beat is “1”, the NIC beat receiver 57a notifies the slave server management unit 57b of an operation of the slave server 10 in the power saving mode. Furthermore, when the “power saving mode” in the NIC beat is “0”, the NIC beat receiver 57a notifies the slave server management unit 57b of an operation of the slave server 10 in the normal mode.

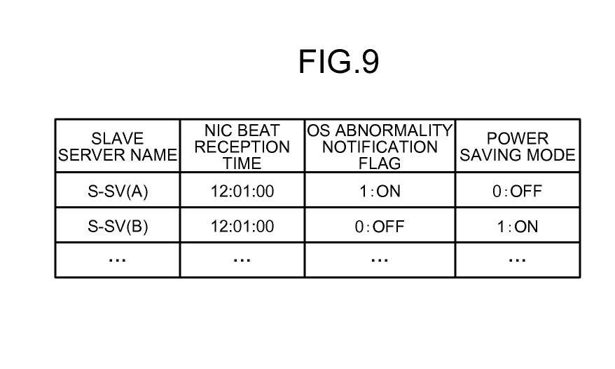

The slave server management unit 57b is a processor that manages the statuses of the respective slave servers 10. To be specific, the slave server management unit 57b generates and manages pieces of information indicating the statuses of the respective slave servers 10 based on various pieces of information notified from the NIC beat receiver 57a. FIG. 9 is a view illustrating an example of the pieces of information that are managed by the slave server management unit.

As illustrated in FIG. 9, the slave server management unit 57b manages “slave server name”, “NIC beat reception time”, “OS abnormality notification flag”, and “power saving mode”. The “slave server name” that is managed thereby is information for identifying the slave server 10, and a host name is set to the “slave server name”, for example. The “NIC beat reception time” indicates the time at which the NIC beat has been received. The “OS abnormality notification flag” is information indicating whether the OS of the slave server has abnormality. When the OS has abnormality, 1 is set as the “OS abnormality notification flag” whereas when the OS has no abnormality, 0 is set to the “OS abnormality notification flag”. The “power saving mode” is information indicating whether an operation mode of the slave server 10 is the power saving mode. When the slave server 10 is in the power saving mode, 1 is set to the “power saving mode” whereas when the slave server 10 is in the normal mode, 0 is set to the “power saving mode”.

For example, the slave server management unit 57b stores the slave server name and the reception time notified from the NIC beat receiver 57a in a storage unit (not illustrated) corresponding to the slave server name and a storage unit of the NIC beat reception time, respectively. When the slave server management unit 57b is notified of abnormality of the OS 53 from the NIC beat receiver 57a, it sets the OS abnormality notification flag of the corresponding slave server name to 1. On the other hand, when the slave server management unit 57b is notified of normality of the OS 53 from the NIC beat receiver 57a, it sets the OS abnormality notification flag of the corresponding slave server name to 0. Furthermore, when the slave server management unit 57b is notified of the operation of the OS 53 in the power saving mode from the NIC beat receiver 57a, it sets the power saving mode of the corresponding slave server name to 1. On the other hand, when the slave server management unit 57b is notified of the operation of the OS 53 in the normal mode from the NIC beat receiver 57a, it sets the power saving mode of the corresponding slave server name to 0.

The notification unit 57c receives the heartbeat contained in the NIC beat received from the slave server 10 from the NIC beat receiver 57a. Then, the notification unit 57c transmits the received heartbeat to the Hadoop 51 through the driver 54 and the OS 53. It is to be noted that the heartbeat transmitted herein has the data structure as illustrated in FIG. 5, for example.

Processing Flow (Sequence)

Next, a series of flow in which each slave server 10 generates the NIC beat based on the heartbeat and transmits it to the master server 50 and the master server 50 grasps a status of the slave server based on the NIC beat is described. The flow in each of the normal operating state, the OS abnormal state, the power saving mode shift state, and the network abnormal state is described.

Normal State

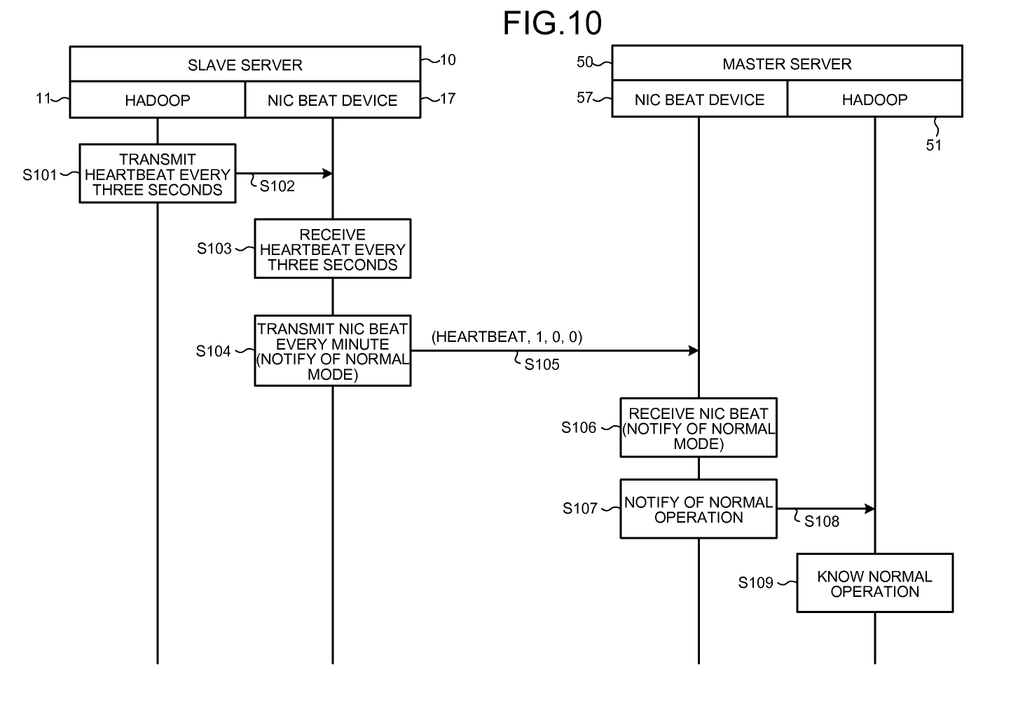

FIG. 10 is a diagram illustrating a sequence in the normal state. The Hadoop 11 of the slave server 10 transmits the heartbeat to the NIC beat device 17 through the OS 13 and the driver 14 every three seconds (S101 and S102). Then, the heartbeat determination unit 17a of the NIC beat device 17 receives the heartbeat every three seconds and updates the status management unit 17c (S103).

The NIC beat generator 17d generates an NIC beat indicating that the slave server 10 is normal every minute and the NIC beat transmitter 17e transmits the NIC beat to the master server 50 (S104 and S105). The NIC beat in this case is formed by the heartbeat, the OS status bit of 1, the WOL function bit of 0, and the OS abnormal bit of 0.

On the other hand, the NIC beat receiver 57a of the master server 50 receives the NIC beat (S106). In this case, the NIC beat receiver 57a extracts the heartbeat and transmits it to the notification unit 57c. The slave server management unit 57b specifies that the OS 13 is normal from the NIC beat and updates the management information.

The notification unit 57c notifies the Hadoop 51 of the heartbeat indicating that the OS 13 operates normally through the driver 54 and the OS 53 (S107 and S108). As a result, the Hadoop 51 knows that the slave server 10 operates normally (S109).

OS Abnormal State

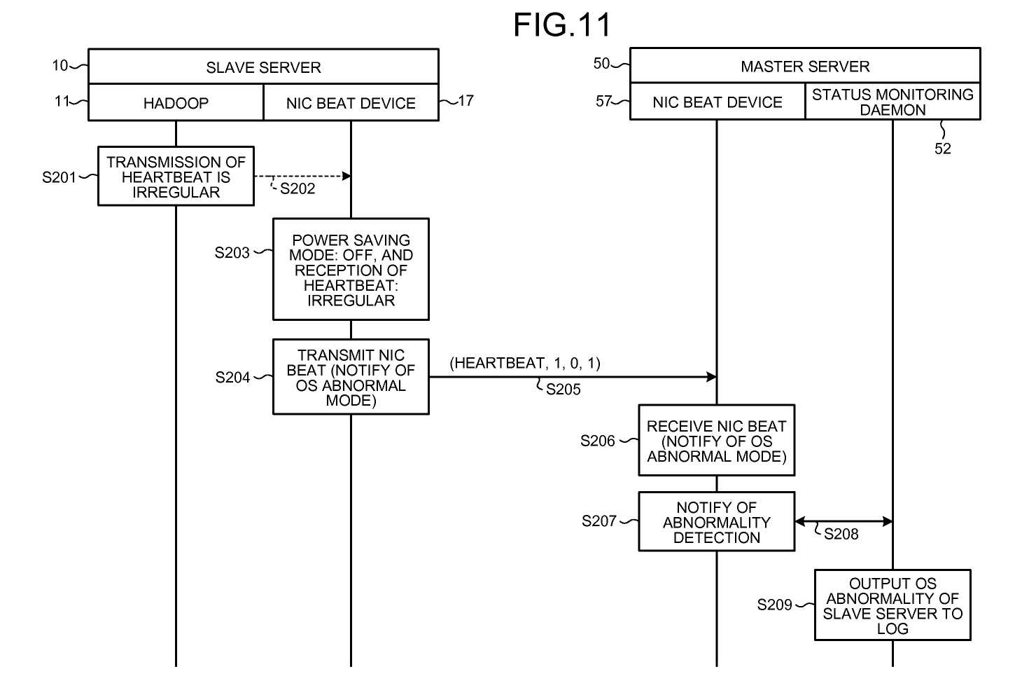

FIG. 11 is a diagram illustrating a sequence in the OS abnormal state. The transmission timing of the heartbeat that is transmitted by the Hadoop 11 of the slave server 10 to the NIC beat device 17 through the OS 13 and the driver 14 is irregular (S201 and S202). Then, the heartbeat determination unit 17a of the NIC beat device 17 determines that the OS 13 is abnormal based on facts that the power saving mode is in an OFF state and the reception timing of the heartbeat is irregular, and updates the status management unit 17c (S203).

The NIC beat generator 17d generates an NIC beat indicating that the OS 13 of the slave server 10 is abnormal and the NIC beat transmitter 17e transmits the NIC beat to the master server 50 (S204 and S205). The NIC beat in this case is formed by the heartbeat, the OS status bit of 1, the WOL function bit of 0, and the OS abnormal bit of 1.

On the other hand, the NIC beat receiver 57a of the master server 50 receives the NIC beat (S206). In this case, the NIC beat receiver 57a extracts the heartbeat and transmits it to the notification unit 57c. The slave server management unit 57b specifies that the OS 13 is abnormal from the NIC beat and updates the management information.

The notification unit 57c notifies the status monitoring daemon 52 of the abnormality of the OS through the driver 54 or the OS 53 (S207 and S208). The status monitoring daemon 52 may monitor the slave server management unit 57b regularly so as to specify that the OS 13 is abnormal. The notification unit 57c notifies the Hadoop 51 of the heartbeat. As a result, the status monitoring daemon 52 outputs a log indicating that the OS 13 of the slave server 10 is abnormal (S209). The Hadoop 51 or the manager detects that the OS of the slave server 10 is abnormal by referring to the log. It is to be noted that the log is stored in the hard disk or the like.

Power Saving Mode Shift State

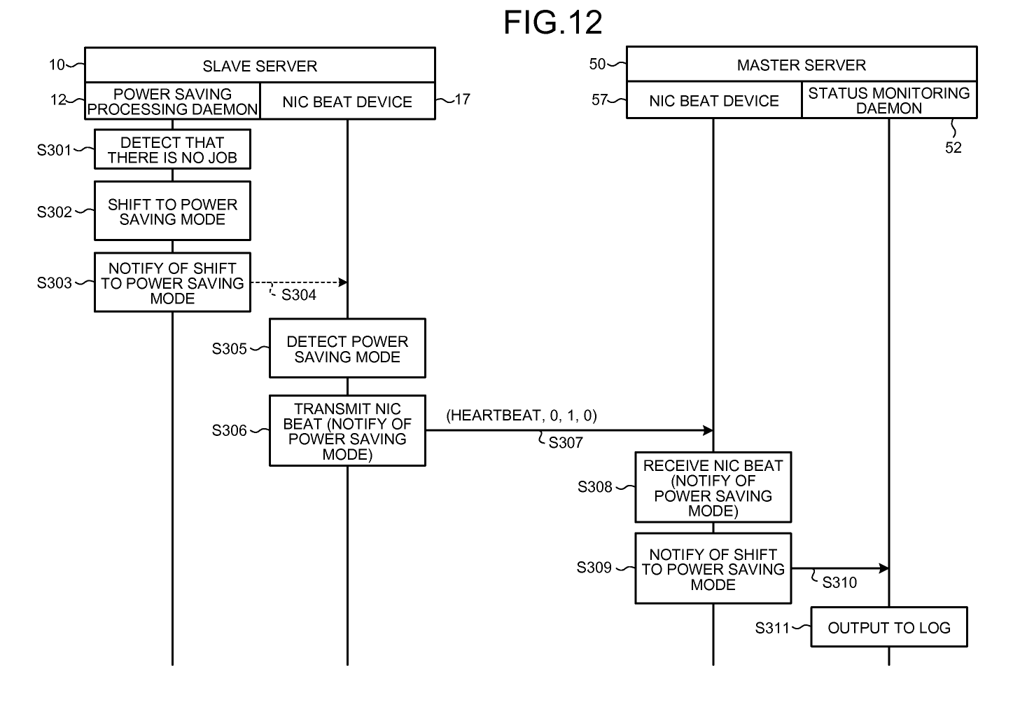

FIG. 12 is a diagram illustrating the sequence in the power saving mode shift state. As illustrated in FIG. 12, when the power saving processing daemon 12 of the slave server 10 detects that there is no job or task to be executed by the OS 13 or the like (S301), it causes the slave server 10 to shift to be in the power saving mode (S302). Subsequently, the power saving processing daemon 12 notifies the NIC beat device 17 of the shift (S303 and S304).

The power saving mode processor 17b detects that the slave server 10 has shifted to be in the power saving mode and notifies the status management unit 17c of it, and the status management unit 17c updates the management information (S305). Thereafter, the NIC beat generator 17d generates an NIC beat indicating that the slave server 10 has shifted to be in the power saving mode, and the NIC beat transmitter 17e transmits the NIC beat to the master server 50 (S306 and S307). The NIC beat in this case is formed by the heartbeat, the OS status bit of 0, the WOL function bit of 1, and the OS abnormal bit of 0.

On the other hand, the NIC beat receiver 57a of the master server 50 receives the NIC beat (S308). In this case, the NIC beat receiver 57a extracts the heartbeat and transmits it to the notification unit 57c. The slave server management unit 57b specifies that the slave server 10 has shifted to be in the power saving mode from the NIC beat and updates the management information.

The notification unit 57c notifies the status monitoring daemon 52 of the shift of the slave server 10 to the power saving mode through the driver 54 or the OS 53 (S309 and S310). The status monitoring daemon 52 may monitor the slave server management unit 57b regularly so as to specify the shift of the slave server 10 to the power saving mode. The notification unit 57c notifies the Hadoop 51 of the heartbeat. As a result, the status monitoring daemon 52 outputs a log indicating that the slave server 10 has shifted to be in the power saving mode (S311). The Hadoop 51 or the manager detects that the slave server 10 has shifted to be in the power saving mode by referring to the log. The slave server 10 that has shifted to be in the power saving mode suppresses generation and transmission of the NIC beat until the power saving mode is cancelled.

Thereafter, the slave server 10 can also detect generation of a job or the like, cancel the power saving mode, and shift to be in the normal mode at the initiative of the slave server 10. Alternatively, the master server 50 can also detect generation of a job or the like on the slave server 10 and cancel the power saving mode at the initiative of the master server 50.

Network Abnormal State

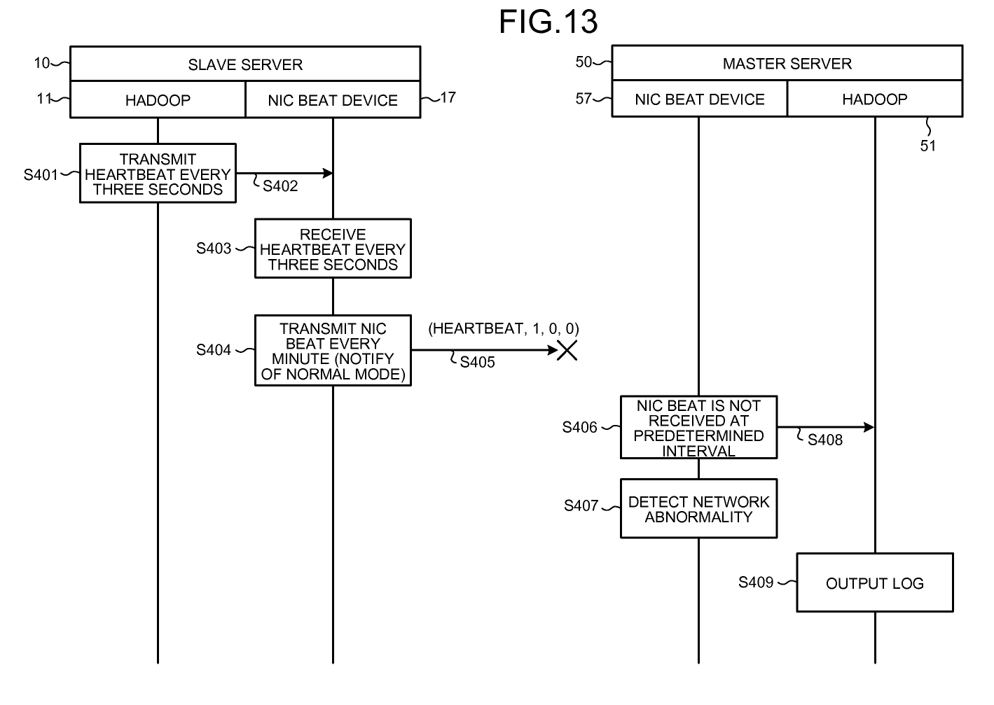

FIG. 13 is a diagram illustrating a sequence in the network abnormal state. As illustrated in FIG. 13, the Hadoop 11 of the slave server 10 transmits the heartbeat to the NIC beat device 17 through the OS 13 and the driver 14 every three seconds as in the normal time (S401 and S402). Then, the heartbeat determination unit 17a of the NIC beat device 17 receives the heartbeat every three seconds and updates the status management unit 17c (S403).

The NIC beat generator 17d generates an NIC beat indicating that the slave server 10 is normal every minute and the NIC beat transmitter 17e transmits the NIC beat to the master server 50 (S404 and S405). The NIC beat in this case is formed by the “heartbeat, the OS status bit of 1, the WOL function bit of 0, and the OS abnormal bit of 0”.

On the other hand, the NIC beat receiver 57a of the master server 50 does not receive the NIC beat even after one minute or a predetermined period of time has elapsed (S406). In this case, the slave server management unit 57b specifies that the NIC beat is not received and the network has abnormality.

Then, the notification unit 57c notifies the Hadoop 51 of the network abnormality notified from the slave server management unit 57b through the driver 54 and the OS 53 (S407 and S408). Thereafter, the Hadoop 51 outputs a log indicating that the network has abnormality (S409). The Hadoop 51 or the manager detects that the network has abnormality by referring to the log.

Slave Server (Flowchart)

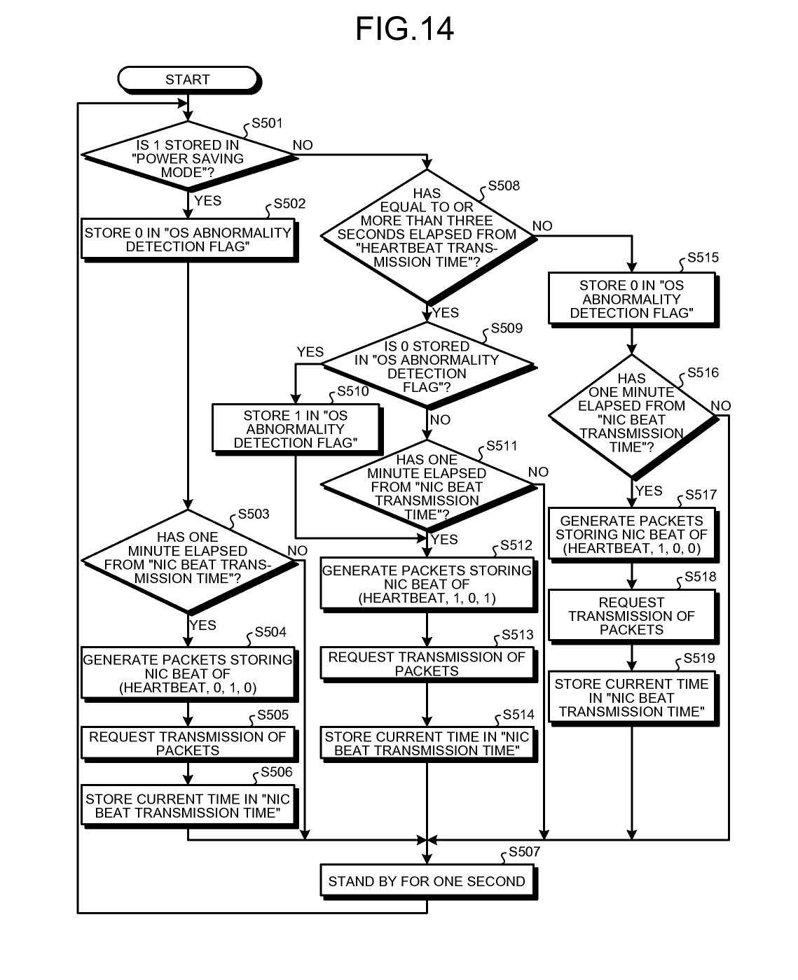

Next, flow of the NIC beat transmission processing that is executed by the slave server 10 is described. FIG. 14 is a flowchart illustrating flow of the NIC beat transmission processing that is executed by the slave server.

As illustrated in FIG. 14, the status management unit 17c of the slave server 10 determines whether “1” is stored in the “power saving mode” that it manages (S501). When the status management unit 17c determines that “1” is stored in the “power saving mode” (Yes at S501), it stores “0” in the “OS abnormality detection flag” (S502).

Subsequently, the NIC beat generator 17d determines whether one minute has elapsed from the “NIC beat transmission time” that is managed by the status management unit 17c (S503). When the NIC beat generator 17d determines that one minute has elapsed from the “NIC beat transmission time” (Yes at S503), it generates an NIC beat formed by the “heartbeat, the OS status bit of 0, the WOL function bit of 1, and the OS abnormal bit of 0” (S504).

The NIC beat transmitter 17e requests the transmission processor 16a of the controller 16 to transmit packets of the NIC beat generated at S504 (S505). Thus, the transmission processor 16a transmits the NIC beat to the master server 50. Thereafter, the NIC beat transmitter 17e notifies the status management unit 17c of the transmission time and the status management unit 17c updates the “NIC beat transmission time” (S506).

After the NIC beat device 17 stands by for one second (S507), it repeats the pieces of processing from S501. When the NIC beat generator 17d determines that one minute has not elapsed from the “NIC beat transmission time” at S503 (No at S503), the NIC beat device 17 executes S507.

On the other hand, when the status management unit 17c determines that “0” is stored in the “power saving mode” (No at S501), it determines whether three seconds has elapsed from the “heartbeat transmission time” (S508).

When the status management unit 17c determines that three seconds has elapsed from the “heartbeat transmission time” (Yes at S508), it determines whether “0” is stored in the “OS abnormality detection flag” (S509). When the status management unit 17c determines that “0” is stored in the “OS abnormality detection flag” (Yes at S509), it updates the “OS abnormality detection flag” to “1” (S510). That is to say, the status management unit 17c determines that the OS 13 has abnormality because the heartbeat is not received regularly. Thereafter, pieces of processing from S512 are executed.

On the other hand, when the status management unit 17c determines that “0” is not stored in the “OS abnormality detection flag” (No at S509), the NIC beat generator 17d determines whether one minute has elapsed from the “NIC beat transmission time” that is managed by the status management unit 17c (S511). When the NIC beat generator 17d determines that one minute has elapsed from the “NIC beat transmission time” (Yes at S511), it generates an NIC beat formed by the “heartbeat, the OS status bit of 1, the WOL function bit of 0, and the OS abnormal bit of 1” (S512).

The NIC beat transmitter 17e requests the transmission processor 16a of the controller 16 to transmit packets of the NIC beat generated at S512 (S513). Thus, the transmission processor 16a transmits the NIC beat to the master server 50. Thereafter, the NIC beat transmitter 17e notifies the status management unit 17c of the transmission time and the status management unit 17c updates the “NIC beat transmission time” (S514).

After the NIC beat device 17 stands by for one second (S507), it repeats the pieces of processing from S501. When the NIC beat generator 17d determines that one minute has not elapsed from the “NIC beat transmission time” (No at S511), the NIC beat device 17 executes S507.

On the other hand, when the status management unit 17c determines that three seconds has not elapsed from the “heartbeat transmission time” (No at S508), it stores “0” in the “OS abnormality detection flag” (S515).

The NIC beat generator 17d determines whether one minute has elapsed from the “NIC beat transmission time” that is managed by the status management unit 17c (S516). When the NIC beat generator 17d determines that one minute has elapsed from the “NIC beat transmission time” (Yes at S516), it generates the NIC beat formed by the “heartbeat, the OS status bit of 1, the WOL function bit of 0, and the OS abnormal bit of 0” (S517).

The NIC beat transmitter 17e requests the transmission processor 16a of the controller 16 to transmit packets of the NIC beat generated at S517 (S518). Thus, the transmission processor 16a transmits the NIC beat to the master server 50. Thereafter, the NIC beat transmitter 17e notifies the status management unit 17c of the transmission time and the status management unit 17c updates the “NIC beat transmission time” (S519).

After the NIC beat device 17 stands by for one second (S507), it repeats the pieces of processing from S501. When the NIC beat generator 17d determines that one minute has not elapsed from the “NIC beat transmission time” (No at S516), the NIC beat device 17 executes S507.

Master Server (Flowchart)

Next, flow of the NIC beat receiving processing and flow of the status monitoring processing that are executed by the master server 50 are described.

NIC Beat Receiving Processing

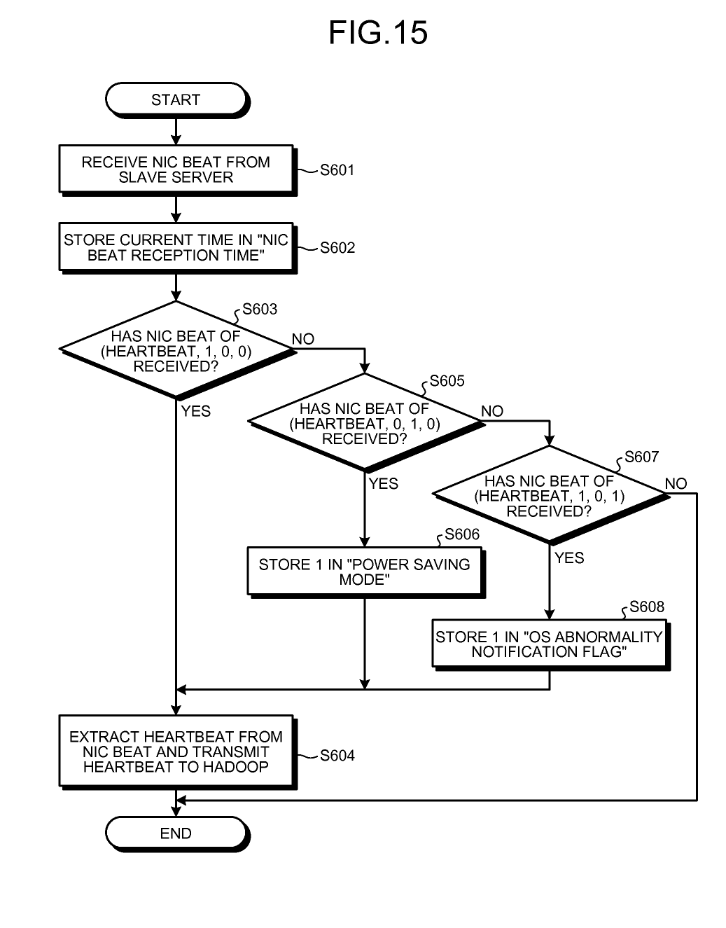

FIG. 15 is a flowchart illustrating flow of the NIC beat receiving processing that is executed by the master server. When the NIC beat receiver 57a of the master server 50 receives the NIC beat from the slave server 10 (S601), it notifies the slave server management unit 57b of the current time (S602). That is to say, the slave server management unit 57b stores the notified current time in the “NIC beat reception time” in the record of the corresponding slave server 10.

Subsequently, the NIC beat receiver 57a determines whether it has received the NIC beat formed by the “heartbeat, the OS status bit of 1, the WOL function bit of 0, and the OS abnormal bit of 0” (S603). That is to say, the NIC beat receiver 57a determines whether it has received the NIC beat indicating no abnormality.

When the NIC beat receiver 57a determines that it has received the NIC beat indicating no abnormality (Yes at S603), the notification unit 57c transmits the heartbeat extracted from the NIC beat by the NIC beat receiver 57a to the Hadoop 51 (S604).

On the other hand, when the NIC beat receiver 57a determines that the received NIC beat is not that formed by the “heartbeat, the OS status bit of 1, the WOL function bit of 0, and the OS abnormal bit of 0” (No at S603), it executes S605. That is to say, the NIC beat receiver 57a determines whether it has received the NIC beat formed by the “heartbeat, the OS status bit of 0, the WOL function bit of 1, and the OS abnormal bit of 0”. In other words, the NIC beat receiver 57a determines whether the slave server 10 operates in the power saving mode.

When the NIC beat receiver 57a determines that the slave server 10 operates in the power saving mode (Yes at S605), the slave server management unit 57b stores “1” in the “power saving mode” for the corresponding slave server 10 (S606). Thereafter, the NIC beat device 57 executes S604.

When the NIC beat receiver 57a determines that the received NIC beat is not that formed by the “heartbeat, the OS status bit of 0, the WOL function bit of 1, and the OS abnormal bit of 0” (No at S605), it executes S607. That is to say, the NIC beat receiver 57a determines whether it has received the NIC beat formed by the “heartbeat, the OS status bit of 1, the WOL function bit of 0, and the OS abnormal bit of 1”. In other words, the NIC beat receiver 57a determines whether the OS 13 of the slave server 10 has the abnormality.

When the NIC beat receiver 57a determines that the OS 13 of the slave server 10 has the abnormality (Yes at S607), the slave server management unit 57b stores “1” in the “OS abnormality notification flag” for the corresponding slave server 10 (S608). Thereafter, the NIC beat device 57 executes S604. When the NIC beat receiver 57a does not determine that the OS 13 of the slave server 10 has the abnormality (No at S607), the NIC beat device 57 finishes the process.

Status Monitoring Processing

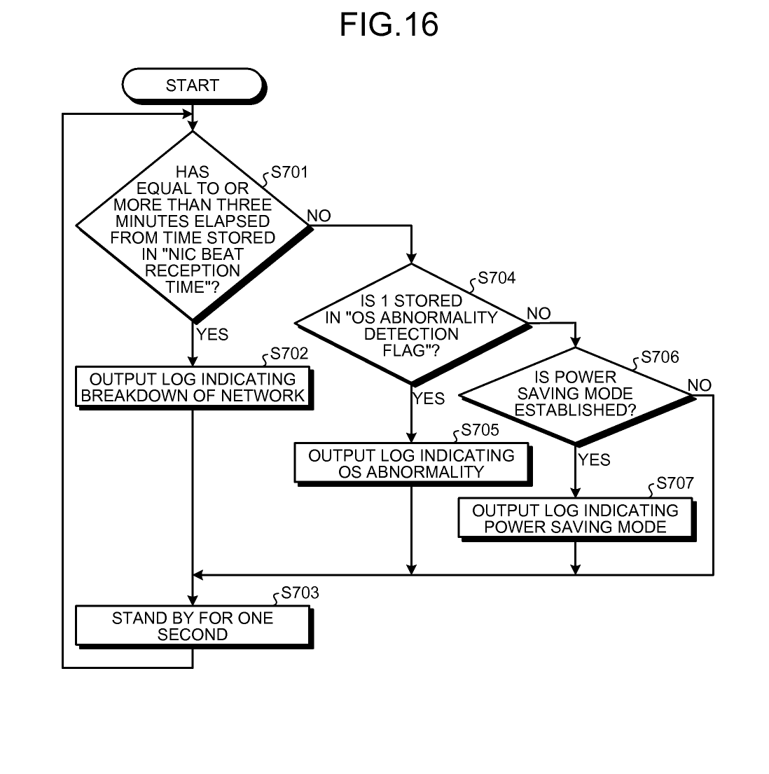

FIG. 16 is a flowchart illustrating the status monitoring processing that is executed by the master server. As illustrated in FIG. 16, the status monitoring daemon 52 of the master server 50 determines whether there is the slave server 10 from which the NIC beat has not been received for equal to or more than three minutes after the NIC beat reception time by referring to the slave server management unit 57b (S701). That is to say, the status monitoring daemon 52 determines whether there is the slave server 10 of which NIC beat reception time that is managed by the slave server management unit 57b has not been updated for equal to or more than three minutes.

When the status monitoring daemon 52 determines that there is the slave server 10 from which the NIC beat has not been received for equal to or more than three minutes after the NIC beat reception time (Yes at S701), it outputs a log indicating that the abnormality is generated on the network (S702). After the status monitoring daemon 52 stands by for one second (S703), it repeats the pieces of processing from S701.

On the other hand, when the status monitoring daemon 52 determines that there is no slave server 10 from which the NIC beat has not been received for equal to or more than three minutes after the NIC beat reception time (No at S701), it determines whether there is the slave server for which “1” is stored in the “OS abnormality notification flag” (S704).

When the status monitoring daemon 52 determines that there is the slave server 10 for which “1” is stored in the “OS abnormality notification flag” (Yes at S704), it outputs a log indicating that the corresponding slave server 10 has the abnormality (S705). After the status monitoring daemon 52 stands by for one second (S703), it repeats the pieces of processing from S701.

When the status monitoring daemon 52 determines that there is no slave server 10 for which “1” is stored in the “OS abnormality notification flag” (No at S704), it determines whether there is the slave server 10 for which “1” is stored in the “power saving mode” (S706).

When the status monitoring daemon 52 determines that there is the slave server 10 for which “1” is stored in the “power saving mode” (Yes at S706), it outputs a log indicating that the slave server 10 has shifted to be in the power saving mode (S707). After the status monitoring daemon 52 stands by for one second (S703), it returns the process to S701 and repeats the pieces of subsequent processing. When the status monitoring daemon 52 determines that there is no slave server 10 for which “1” is stored in the “power saving mode” (No at S706), it stands by for one second (S703), and then, it returns the process to S701 and repeats the pieces of subsequent processing.

In this manner, in comparison with the heartbeat that is transmitted every three seconds as in the conventional technique, the load on the master server 50 can be reduced by using the NIC beat of which transmission timing and the like can be changed flexibly with no single transmission rule. In addition, the NIC beat is used so as to keep the function of transmitting the running information of the heartbeat and specify a trouble place. Furthermore, erroneous determination of the trouble place for the slave server 10 can be prevented, thereby improving efficiency of the operations for the causes of the trouble.

The slave servers 10 that have completely finished job processing are made into the power saving modes, thereby reducing power cost largely. In addition, the slave servers 10 transmit the NIC beats, so that erroneous determination by the master server 50 for the slave servers 10 that have shifted to be in the power saving mode can be prevented. Moreover, each slave server 10 can be recovered to be in the normal processing mode from the power saving mode in accordance with the request of job processing by the master server 50.

Furthermore, abnormality on the OS and a trouble on the network can be distinguished, thereby immediately starting switching to a substitute slave server 10 when the OS has the abnormality. In addition, there is no possibility that pieces of data stored in the slave servers 10 corrupt when the network has the trouble. This enables the master server 50 to change a coping way for the slave servers 10 flexibly, for example, so as to wait for recovery of the network.

### [b] Second Embodiment

Although the embodiment of the invention has been described hereinbefore, the invention may be carried out in various different modes other than the above-mentioned embodiment. The following describes different embodiments.

Notification Contents

Although the OS status bit, the power saving mode, and the OS abnormal bit are transmitted in the form of the NIC beat in the first embodiment, they are not limited to be transmitted in this manner and any one of them may be transmitted. Alternatively, an arbitrary combination of them may be transmitted.

Transmission Interval

Although the heartbeat is transmitted every three seconds and the NIC beat is transmitted every one minute in the first embodiment, the intervals are not limited thereto. The transmission intervals of them can be arbitrarily changed to be set. It is to be noted that the transmission interval of the NIC beat is preferably longer than the transmission interval of the heartbeat in order to reduce the load on the master server 50.

System

All or a part of the pieces of processing that have been described to be executed automatically among the respective pieces of processing described in the embodiment can be also performed manually. Alternatively, all or a part of the pieces of processing that have been described to be executed manually can be also performed automatically with a well-known method. In addition, processing procedures, control procedures, specific technical terms, various pieces of data, and pieces of information including parameters in the above-mentioned description and drawings can be changed arbitrarily unless otherwise specified.

The components of each unit illustrated in the drawings are only for conceptually illustrating the functions thereof and are not always physically configured as illustrated in the drawings. That is to say, specific forms of disintegration and integration of the devices are not limited to those as illustrated in the drawings, and all of or a part of them can be configured to be disintegrated or integrated functionally or physically based on an arbitrary unit depending on various loads and usage conditions. In addition, all or an arbitrary part of the respective processing functions that are executed by the respective devices can be achieved by the CPU and the programs to be analyzed and executed by the CPU, or can be achieved by hardware by a wired logic.

According to the embodiment of the invention, an occurrence place of the trouble can be distinguished.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a first information processing apparatus; and
a second information processing apparatus that monitors the first information processing apparatus,
the first information processing apparatus including:
a first input/output device;
a processor which executes an operating system and
a first input/output unit that is capable of communicating with the second information processing apparatus and transmits a notification signal transmitted from the first input/output device to the second information processing apparatus even when no notification from the operating system is obtained, and
the second information processing apparatus including:
a second input/output device; and
a trouble detector that detects occurrence of a trouble on the network when the second input/output device does not receive the notification signal from the first input/output device.

2. The information processing system according to claim 1, wherein
the first input/output unit includes a generator that generates status information of the operating system based on the notification from the operating system, and
the first input/output unit transmits the notification signal including the status information generated by the generator to the second information processing apparatus.

3. The information processing system according to claim 2, wherein
the generator generates abnormality notification information indicating that the first information processing apparatus has abnormality when a generation cycle of notification from the operating system is irregular or when no notification from the operating system is received,
the first input/output unit transmits the notification signal including the abnormality notification information generated by the generator to the second information processing apparatus, and
the trouble detector detects occurrence of a trouble on the first information processing apparatus when the notification signal received from the first information processing apparatus includes the abnormality notification information.

4. The information processing system according to claim 2, wherein
the generator generates shift notification information indicating that the first information processing apparatus shifts to be in a power saving mode of reducing power consumption when there becomes no job to be executed by the first information processing apparatus,
the first input/output unit transmits the notification signal including the shift notification information generated by the generator to the second information processing apparatus, and
the trouble detector of the second information processing apparatus excludes the first information processing apparatus from a monitoring target when the notification signal received from the first information processing apparatus includes the shift notification information.

5. The information processing system according to claim 4, wherein the first input/output unit suppresses transmission of the notification signal until the power saving mode is cancelled after the notification signal including the shift notification information is transmitted to the second information processing apparatus.

6. The information processing system according to claim 5, wherein
the generator generates cancellation notification information indicating that the power saving mode is cancelled when the job occurs on the first information processing apparatus,
the first input/output unit transmits the notification signal including the cancellation notification information generated by the generator to the second information processing apparatus, and
the trouble detector returns the first information processing apparatus to a monitoring target when the notification signal received from the first information processing apparatus includes the cancellation notification information.

7. A trouble detecting method comprising:
by a first information processing apparatus, communicating with a second information processing apparatus and transmitting a notification signal transmitted from a first input/output device of the first information processing apparatus to the second information processing apparatus even when no notification from an operating system that is operated by a processor of the first information processing apparatus is obtained; and
by the second information processing apparatus, detecting occurrence of a trouble on a network when a second input/output device of the second information processing apparatus does not receive the notification signal from the first input/output device.

8. An information processing apparatus comprising:
a first input/output device;
a processor which executes an operating system; and
a first input/output unit that is capable of communicating with a monitoring apparatus and transmits a notification signal transmitted from the first input/output device to the monitoring apparatus even when no notification from the operating system is obtained.

9. An information processing apparatus comprising:
a second input/output device; and
a trouble detector that detects occurrence of a trouble on a network between an apparatus as a monitoring target and the information processing apparatus when the second input/output device does not receive a notification signal from the apparatus as the monitoring target.
